(19) United States
(12) Patent Application Publication
(10) Pub. No.: US 2013/0048083 A1
(43) Pub. Date: Feb. 28, 2013

(54) REMOTE CONTROLLED GRAYWATER SEPARATION SYSTEM AND METHOD FOR USING SAME

(71) Applicant: Garry Sato, Santa Monica, CA (US)

(72) Inventor: Garry Sato, Santa Monica, CA (US)

(21) Appl. No.: 13/216,167

(22) Filed: Aug. 23, 2011

(51) Int. Cl. F15D 1/00

(52) U.S. Cl. 137/1; 137/862

(57) ABSTRACT

Described herein is a graywater separation valve assembly that includes a main body portion, valve means remotely operable by a user, a motor operatively connected to the valve means, a receiver in electrical communication with the motor, and a remote control that includes a transmitter in communication with the receiver and for operating the valve means. The main body portion includes an inlet, which, in use, is connected to a graywater source, a first outlet, which, in use, is connected to a sewer line, and a second outlet, which, in use, is connected to a graywater line. The inlet, first outlet and second outlet all comprise no hub connectors. The remote control is operable to cause graywater received through the inlet to pass through either the first outlet or the second outlet.

### FIELD OF THE INVENTION

The present invention relates to a remote controlled graywater separation valve and system.

### BACKGROUND OF THE INVENTION

As pressures on freshwater resources grow around the world and as new sources of supply become increasingly scarce, expensive, or politically controversial, efforts are underway to identify new ways of meeting water needs. Of special note are efforts to reduce water demand by increasing the efficiency of water use and to expand the uses of alternative sources of water previously considered unusable. Among these potential new sources of supply is “graywater.”

Graywater generally refers to the wastewater generated from household uses like bathing and washing clothes. This wastewater is distinguished from more heavily contaminated “black water” from toilets. In many utility systems around the world, graywater is combined with black water in a single domestic wastewater stream. Yet graywater can be of far higher quality than black water because of its low level of contamination and higher potential reuse. When graywater is reused either onsite or nearby, it has the potential to reduce the demand for new water, reduce the energy and carbon footprint of water services, and meet a wide range of social and economic needs. In particular, the reuse of graywater water can help reduce demand for more costly high-quality potable water.

By appropriately matching water quality to water need, the reuse of graywater can replace the use of potable water in non-potable applications like toilet flushing and landscaping. For instance, many homes have one set of pipes that bring potable drinking water in for multiple uses and another that takes water away. In this system, all devices that use water and all applications of water use a single quality of water: highly treated potable drinking water. This water is used once and then it enters a sewer system to be transported and treated again, in places where wastewater treatment occurs. In most modern wastewater systems treated wastewater is then disposed of into the ocean or other water bodies, voiding the reuse potential of this treated wastewater. In other places, once used wastewater may be disposed directly into the environment. This system wastes water, energy, and money by not matching the quality of water to its use.

A graywater system, on the other hand, captures water that has been used for some purpose, but has not come into contact with high levels of contamination, e.g. sewage or food waste. This water can be reused in a variety of ways. For instance water that has been used once in a shower, clothes washing machine, or bathroom sink can be diverted outdoors for irrigation. In this case, the demand for potable water for outdoors irrigation is reduced and the streams of wastewater produced both by the shower, washing machine, and sink are reduced. When the systems are designed and implemented properly, possible public health concerns with using different water qualities can be addressed. The present invention addresses these concerns in at least one embodiment by separating “clean” graywater (e.g., graywater from when the shower is run while the water is warming up) from “not so clean” graywater (e.g., graywater that includes soap and residue from rinsing off after washing one's hair or body). In this embodiment, the ability to selectively separate and direct clean graywater from the less clean graywater on the fly, the bacterial and contaminant levels present should be found to be lower than previous historic readings. Attention to public health impacts of water reuse is also important in scaling up graywater solutions in areas where regulations around water reuse are not well enforced. Many attempts at graywater systems have proven unsuccessful or inefficient.

Accordingly, a need exists for an efficient system for recycling the relatively large amounts of water used for showering, bathing or washing clothes.

### SUMMARY OF THE PREFERRED EMBODIMENTS

Described herein is a retrofittable, homeowner friendly, remote-controlled, optional stub-out, graywater collection valve assembly unit, which includes flexible no-hub connectors so that the entire valve unit can be removed for service or replacement without having to saw or otherwise damage any pipes. The valve unit can be installed easily by the homeowner or a handyman or can be installed as an optional stub-out during new construction.

In accordance with a first aspect of the present invention there is provided a graywater separation valve assembly that includes a main body portion, valve means remotely operable by a user, a motor operatively connected to the valve means, a receiver in electrical communication with the motor, and a remote control that includes a transmitter in communication with the receiver and for operating the valve means. The main body portion includes an inlet, which, in use, is connected to a graywater source a first outlet, which, in use, is connected to a sewer line, and a second outlet, which, in use, is connected to a graywater line. The inlet, first outlet and second outlet all comprise no hub connectors. The remote control is operable to cause graywater received through the inlet to pass through either the first outlet or the second outlet.

In accordance with another aspect of the present invention there is provided a method that includes providing a graywater valve assembly connected to the plumbing of a graywater source selected from one of a bathtub, shower, sink or washing machine. The graywater valve assembly includes a main body portion that has an inlet connected to the graywater source, a first outlet connected to a sewer line, a second outlet connected to a graywater line, valve means positioned in the main body portion that is remotely operable by a user, a motor operatively connected to the valve means, a receiver in electrical communication with the motor, and a remote control that includes a transmitter in communication with the receiver and for operating the valve means. The method includes operating the remote control to selectively cause graywater received through the inlet to pass through either the first outlet such that it is directed to the sewer line or the second outlet such that it is directed to the graywater line.

In accordance with another aspect of the present invention there is provided a method for separating graywater that includes the steps of providing a bathtub or shower that includes a graywater separation assembly having a valve means that is movable between a first position where water is directed to a sewer and a second position where water is directed to a graywater line, operating a remote control to place the valve means in the second position, turning the shower water on, operating the remote control to place the valve means in the first position, operating the remote control to place the valve means in the second position, and turning the shower water off. In a preferred embodiment, the steps where the remote control is operated are performed from within the bathtub or shower. Preferably, the remote control is not in mechanical communication with the valve means.

The invention, together with additional features and advantages thereof, may be best understood by reference to the following description.

### BRIEF DESCRIPTION OF THE DRAWINGS

FIG. 1 is an illustration of a home with a graywater separation system having a dual outlet valve assembly installed in a shower and the washer;

FIG. 2 is an illustration of the graywater separation system of FIG. 1 installed in the shower and showing a user operating the remote control;

FIG. 3A is a cross-sectional elevational view of a valve assembly from the graywater separation system of FIG. 1, showing the valve in a first position;

FIG. 3B is a cross-sectional elevational view of a valve assembly from the graywater separation system of FIG. 1, showing the valve in a second position;

FIG. 4 is an elevational view of the valve assembly of FIG. 1 with the cover removed from the casing to show the receiver and motor therein;

FIG. 5 is a perspective view of the valve assembly of FIG. 1 with a stub-out; and

FIG. 6 is a perspective view of the valve assembly of FIG. 1 connected to a graywater line and using no-hub connectors.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an other embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” and “below” used herein are merely for ease of description and refer to the orientation of the components as shown in the figures. It should be understood that any orientation of the components described herein is within the scope of the present invention.

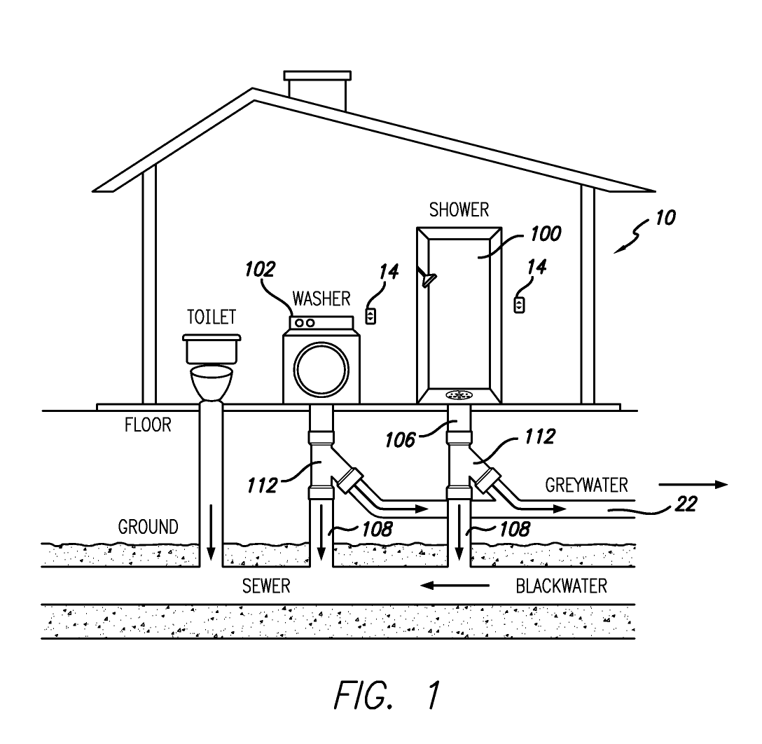

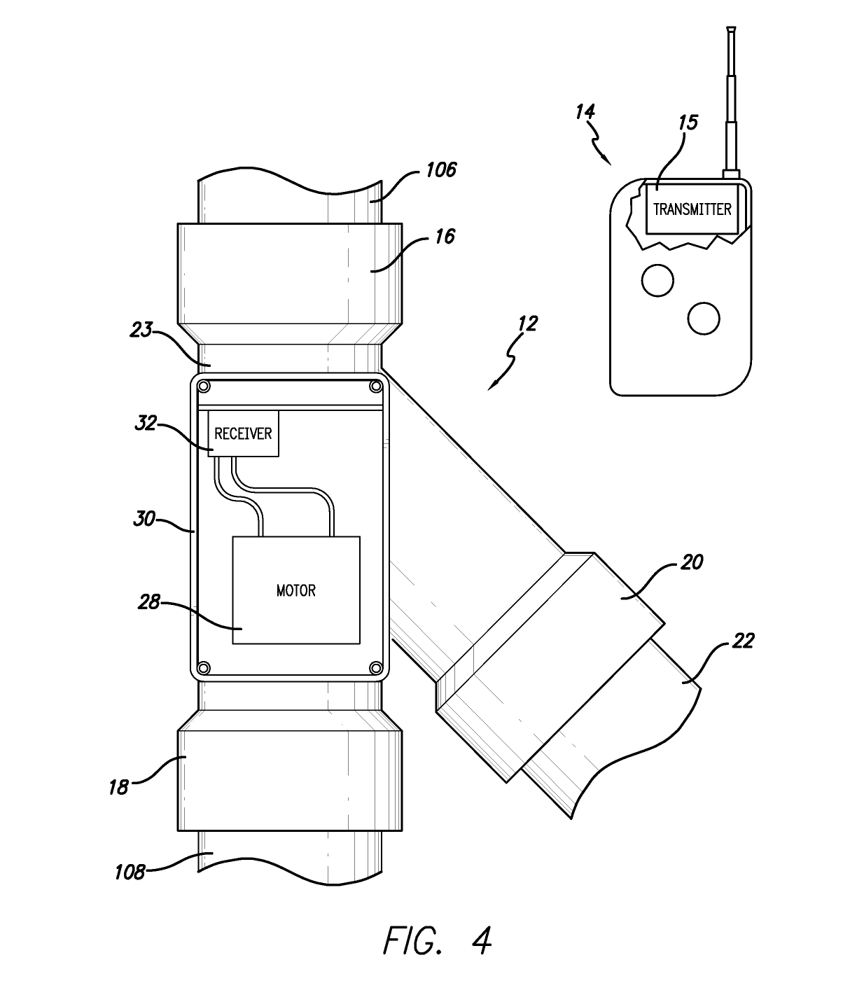

Referring now to the drawings, wherein the showings are for purposes of illustrating the present invention and not for purposes of limiting the same, FIGS. 1-6 show the preferred use of a water-conservation or graywater separation system 10. The system 10 generally includes a dual outlet valve assembly 12 and a remote control device 14. In a preferred embodiment, the system 10 is designed for home use in conjunction with standard plumbing in a shower 100, bathtub, washer 102, sink or any other household item that uses water and includes a drain 106 (referred to herein as a “graywater source”). However, this is not a limitation on the invention, the system 10 can be used outside of the home, such as in industrial settings and the like (also considered a graywater source). In other embodiments, the system can be used for separating air, dust, heat, smoke and the like. For exemplary purposes, the system 10 will be described herein as being used with a shower 100.

A standard shower 100 includes a drain outlet 106. Preferably, the valve assembly 12 includes an inlet port 16, a first outlet port 18 and a second outlet port 20. The drain outlet 106 is connected to the inlet port 16 of the valve assembly 12, the first outlet port 18 is connected to a sewer line 108 and the second outlet port 20 is connected to a recycle/graywater water line 22 leading to a storage tank (not shown). The graywater that is diverted to the storage tank may be used for purposes such as outside irrigation, toilet flushing and aquifer regeneration, among other uses. In a preferred embodiment, the valve assembly 12 is gravity fed (due to its vertical location underneath the drain 106); however, this is not a limitation on the present invention and the assembly 12 can be oriented non-vertically or horizontally.

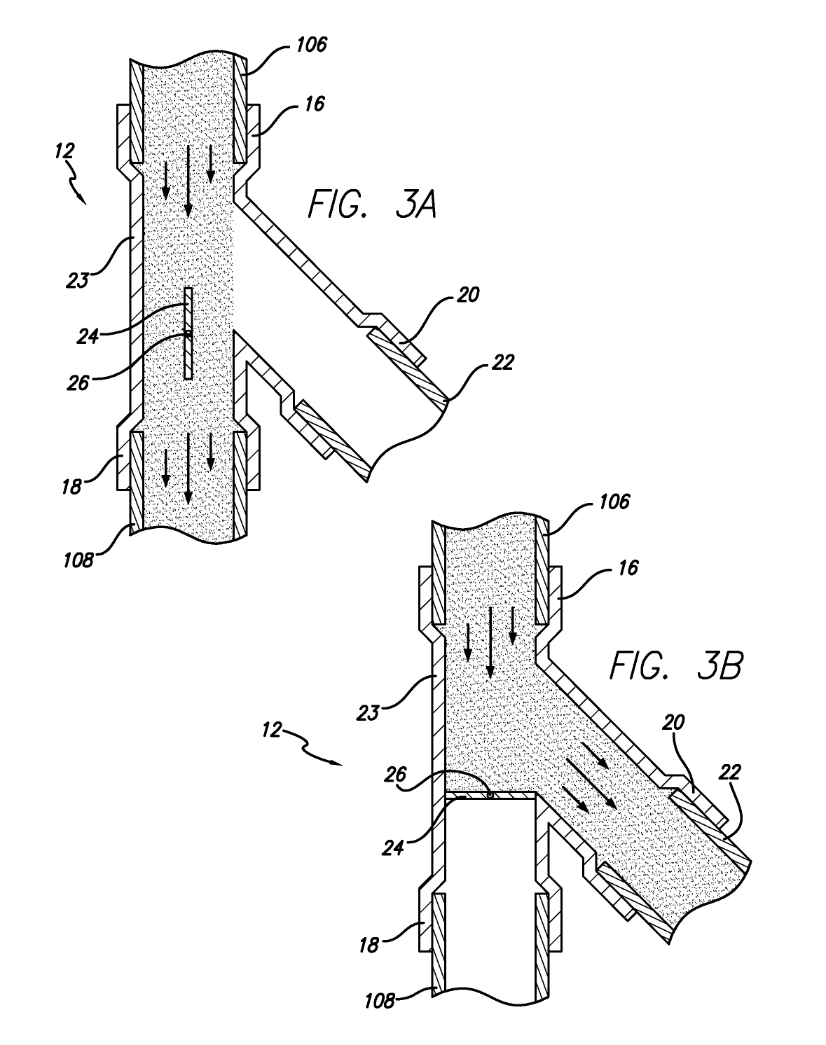

With reference to FIGS. 3A-6, the preferred embodiment of the dual outlet valve assembly 12 of the present invention is shown in detail. As described above, the valve assembly 12 includes a main body portion 23 that preferably includes an inlet port 16 and two outlet ports 18 and 20. In another embodiment, the valve assembly 12 includes more than one inlet port; for example, when used with a bathtub that includes an overflow valve. In a preferred embodiment, inlet 16 and first outlet 18 are sized and positioned such that the valve assembly 12 may be retrofitted into existing bathtubs, showers, washing machines, etc. without rearrangement of existing plumbing lines. In an exemplary embodiment, the valve housing or main body portion 23 is a 2″-3″ diameter, 3-way, ABS, black, Y sewer line plumbing connector. This makes the assembly 12 adaptable to existing or future systems, pumps, tanks, filters, etc. It should be understood that this example is not limiting and the components can be any size, shape or color.

In a preferred embodiment, the valve assembly 12 includes a butterfly valve mechanism that includes a rotatable member 24, shown in cross-section in FIGS. 3A and 3B, that provides a rotatable means for alternatively directing water through the first outlet 18 or diverting water through the second outlet 20, such that water from the first inlet 16 flows out the second outlet 20 when the first outlet 18 is blocked and out the first outlet 18 when the first outlet 18 is not blocked. In FIG. 3A, the member 24 is oriented to allow the water to flow through inlet 16, past member 24, through second outlet 20 and to the sewer (referred to herein as the first position). As an example, this orientation would be used while the user is soaping up during a shower. FIG. 3B shows the member 24 oriented to divert the flow of water through second outlet 20 (or block it from going to the sewer) and to the gray water storage tank (referred to herein as the second position). As an example, this orientation would be used when a user is running the water in the shower 100, before getting in or after washing when the user is relaxing. In another embodiment, the rotatable member 24 can be positioned such that it blocks the second outlet 20 in the second position, thereby allowing water to flow through the first outlet 18. In an exemplary use of the present invention, a user could press the remote multiple times during a single shower to alternate between directing water to the graywater storage tank and the sewer. For example, the user can set the valve 12 to the first position when running the water before getting in. Then, once the user soaps up, they can set the valve to the second position so that the water with the soap is directed to the sewer. Then, the user can switch the valve 12 back to the first position after the soap has gone down the drain 106. This provides the ability to selectively separate and direct clean graywater from the less clean graywater “on the fly.”

As is shown in FIGS. 3A and 3B, the rotatable member 24 is seated on a mounting shaft 26. Mounting shaft 26 is operatively connected to a motor 28 (or other control means) that is housed in a casing 30 that is secured to main body portion 23 and includes a removable cover 31. The removable cover 31 can be secured to the casing 30 via threaded receivers or the like. The casing 30 is preferably permanently secured via gluing, welding or the like to the main body portion 23. In another embodiment, the casing 30 can be removable from the main body portion 23. The motor 28 includes a source of power, which can be DC or AC. In a preferred embodiment, the motor 28 includes batteries. However, in another embodiment, the motor 28 can be in electrical communication with an AC source, such as a standard wall outlet. In an exemplary embodiment, the butterfly valve comprises two parts, a round galvanized sheet metal disk (rotatable member 24) and a brass mounting shaft 28. The mounting shaft 28 supports the valve disk 24 as well as an activator arm that activates the limit switches as the motor 28 rotates in either direction. This example is not limiting.

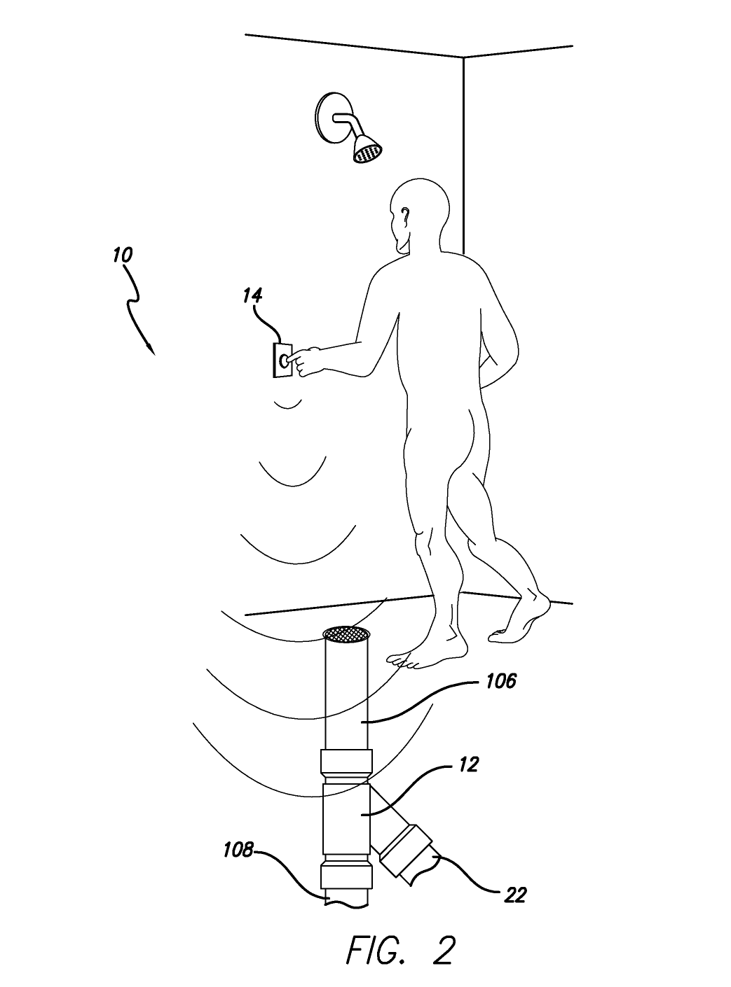

In a preferred embodiment, the motor 28 is in electrical communication with a receiver 32 from which it receives commands to selectively move member 24 between the first position and the second position. The receiver 32 receives signals from a transmitter 15 located in the remote control device 14. As shown in FIG. 2, the remote control device 14 can be mounted on the wall of the shower 100 (and can be waterproof or otherwise housed in a waterproof casing). In another embodiment, the remote control device 14 can be loose or portable or mounted in another location, such as on a shelf, door or the like. In the embodiment shown in the figures, the remote control transmitter and receiver communicate via radio frequency signals. Any remote control device or transmitter/receiver combination is within the scope of the present invention. In the embodiment shown in the figures, the remote control device operates via radio frequency. However, in another embodiment, the remote control device can be a cell phone, tablet, computer or the like that includes an application (“app”) or software for operating the valve.

It will be appreciated that any type of valve means that can divert water through one outlet or another is within the scope of the present invention. Furthermore, any type of motor that can operate the valve means is within the scope of the present invention. The valve can be operated electrically, pneumatically, hydraulically, etc.

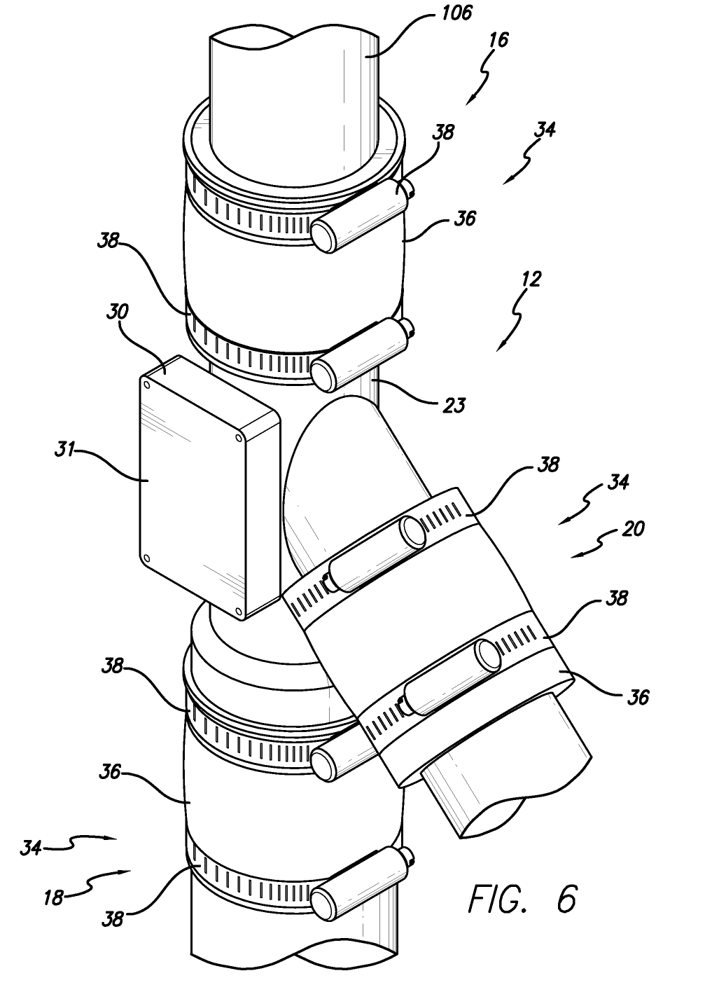

The valve assembly 12 can be installed into existing plumbing or in plumbing as a new home is built. And, any known method for connecting the main body portion 23 to the drain pipe 106, sewer line 108 or graywater line 22 is within the scope of the present invention. As shown in FIG. 6, in a preferred embodiment, no hub connectors 34 are used for connecting the valve assembly 12 to the drain pipe 106, sewer line 108 or graywater line 22. A flexible no hub connector 34 includes a rubber connector or sleeve 36 with hose clamps 38 and is used to connect two sections of pipe or fitting together without cutting or gluing. This allows for easy installation and replacement with common tools.

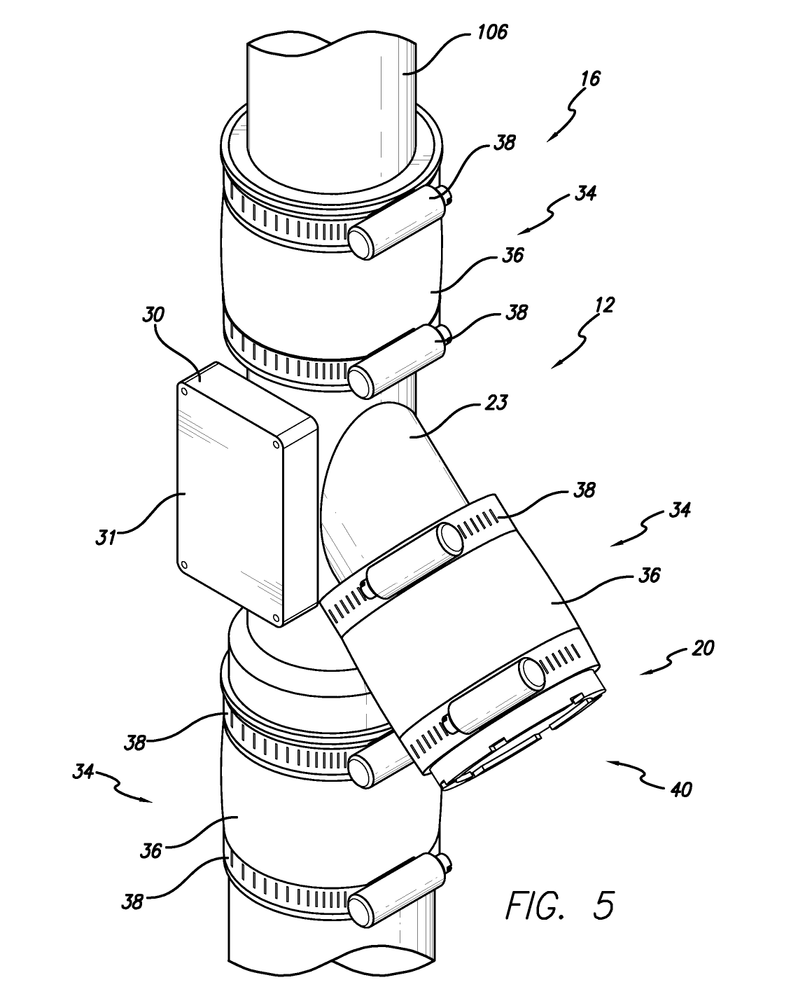

As shown in FIG. 5, in use, the valve assembly 12 can be installed and include a stub-out 40 for future use. A stub-out 40 is the graywater collection plumbing which dead ends at a cap 42. This is typically installed with the intent to be connected to a distribution system at a later date. When the valve assembly 12 is installed with the second outlet 30 capped as a stub-out 40, it provides for future connection to and installation of a graywater collection tank.

In the “stub-out scenario,” a home builder builds a new home with the shower, washer, etc. including the valve assembly 12 of the present invention, but with a stub out 40, as shown in FIG. 5. At a later time, the home owner can install a graywater storage tank and run a line 22 to the stub-out 40, where the cap 42 is removed and the second outlet 20 is connected to the line 22, as shown in FIG. 6.

In an embodiment where the system 10 is installed with a washer, the system can be automated such that the valve is moved between the first and second positions based on predetermined conditions in the washer (e.g., a timer), instead of having the user control the valve. For example, the electronics of the washer could be set to direct water to the sewer when the soapy water is expelled, but to the graywater line during the rinse cycle.

A dual outlet valve assembly 12 of the present invention is easily installed in pre-existing prior art plumbing by a kit in accordance with the present invention. The kit includes the valve assembly 12 (both the main body portion 23, casing 30 and internal components) and the remote control device 14. In another embodiment, the kit can include no hub connectors 34.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed, at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”). Accordingly, the applicant reserves the right to add additional claims after filing the application to pursue such additional claim forms for other aspects of the disclosure.

Accordingly, although exemplary embodiments of the invention have been shown and described, it is to be understood, that all the terms used herein are descriptive rather than limiting, and that many changes, modifications, and substitutions may be made by one having ordinary skill in the art without departing from the spirit and scope of the invention.

What is claimed is:

1. A graywater separation valve assembly:
a main body portion that includes
an inlet, which, in use, is connected to a graywater source
a first outlet, which, in use, is connected to a sewer line, and
a second outlet, which, in use, is connected to a graywater line,
wherein the inlet, first outlet and second outlet all comprise no hub connectors, valve means remotely operable by a user to cause graywater received through the inlet to pass through either the first outlet or the second outlet,
a motor operatively connected to the valve means,
a receiver in electrical communication with the motor, and
a remote control that includes a transmitter in communication with the receiver and for operating the valve means.

2. The assembly of claim 1 wherein the transmitter and receiver communicate via radio frequency.

3. The assembly of claim 2 wherein the valve means includes a rotatable member that is movable between a first position and a second position.

4. The assembly of claim 3 wherein the motor and receiver are housed within a casing having a removable cover, wherein the casing is secured to the main body portion.

5. The assembly of claim 4 wherein the remote control is waterproof.

6. A method comprising the steps of:
(a) providing a graywater valve assembly connected to the plumbing of a graywater source selected from one of a bathtub, shower, sink or washing machine, wherein the graywater valve assembly includes a main body portion having an inlet connected to the graywater source, a first outlet connected to a sewer line, and a second outlet connected to a graywater line, valve means positioned in the main body portion and remotely operable by a user, a motor operatively connected to the valve means, a receiver in electrical communication with the motor, and a remote control that includes a transmitter in communication with the receiver and for operating the valve means,
(b) operating the remote control to selectively cause graywater received through the inlet to pass through either the first outlet such that it is directed to the sewer line or the second outlet such that it is directed to the graywater line.

7. The method of claim 6 wherein the graywater valve assembly is connected to the plumbing of a bathtub or shower, and wherein step (b) is performed from within the bathtub or shower.

8. The method of claim 7 wherein the remote control is mounted on the wall of the bathtub or shower.

9. A method for separating graywater, the method comprising the steps of:
a) providing a bathtub or shower that includes a graywater separation assembly having a valve means that is movable between a first position where water is directed to a sewer and a second position where water is directed to a graywater line,
b) operating a remote control to place the valve means in the second position,
c) turning the shower water on,
d) operating the remote control to place the valve means in the first position,
e) operating the remote control to place the valve means in the second position, and
f) turning the shower water off.

10. The method of claim 9 wherein steps b, d and e are performed from within the bathtub or shower.

11. The method of claim 9 wherein the remote control is not in mechanical communication with the valve means.
